(19) United States
(12) Patent Application Publication
(10) Pub. No.: US 2007/0152064 A1
(43) Pub. Date: Jul. 5, 2007

(54) Diffuse light ring for reading encoded symbols

(76) Inventors: Laurens Nunnink, Simpelveld (NL); Carl W. Gerst III, Boston, MA (US); Richard Reuter, Wurselen (DE)

Correspondence Address: COGNEX CORPORATION;INTELLECTUAL PROPERTY DEPARTMENT, 1 VISION DRIVE, NATICK, MA, 01760-2077, US

(21) Appl. No.: 11/322,370

(22) Filed: Dec. 30, 2005

(51) Int. Cl. G06K 7/10

(52) U.S. Cl. 235/462.42; 235/454; 235/473

(57) ABSTRACT

A scanning device includes a light ring that is constructed of light emitting diodes that are directed toward the center of the ring and emit diffuse light over a radiation spectrum having an angle of greater than ninety degrees. The light ring provides both low angle and high angle light, and therefore dark and bright field illumination.

### BACKGROUND OF THE INVENTION

The present invention relates to scanning devices for decoding symbols, and more particularly to a scanning device for providing both bright and dark field illumination.

### BACKGROUND

Machine vision systems use image acquisition devices such as a CMOS or CCD camera sensor to acquire images of encoded symbols, including, for example, bar codes, data matrixes, and other symbols. The acquired image can then be processed using an identification algorithm to decode the pattern provided in the symbol, and therefore to acquire data about the object to which the symbol is affixed. These devices are well known for use in both retail and manufacturing environments for providing pricing objects, monitoring and maintaining stock, and tracking industrial parts.

Effective acquisition and processing of a symbol by the machine vision system requires the object containing the symbol to be properly illuminated. Effective illumination often requires one or more type of angled lighting. Where barcodes or other viewed subjects are printed on a flat surface with contrasting ink or paint, for example, a diffuse, high-angle “bright field” illumination may best highlight these features. By high-angle it is meant, generally, that light strikes the subject nearly perpendicularly (normal to the surface) or at an angle that is typically no more than about 45 degrees from perpendicular to the surface of the item being scanned. Such illumination is subject to substantial reflection back toward the sensor from the illuminated surface.

Conversely, where a barcode or other subject is formed on an irregular surface, the use of highly reflective bright field illumination may not provide adequate illumination. A peened or etched surface, for example, has two-dimensional properties that tend to scatter bright field illumination, thereby obscuring an image acquired from such a surface. Here, it is typically better to illuminate the surface using a low angle, or “dark field” illumination, where low angle means approximately 45 degrees or less with respect to the surface of the subject, e.g. an angle of more than approximately 45 degrees with respect to normal. When using low-angle, dark field illumination, three-dimensional surface texture is contrasted more effectively for better image acquisition. Therefore, for example, indents will appear as bright spots and the surround area as shadow, making identification of the symbol easier.

To take full advantage of the versatility of a camera image sensor, it is desirable to provide both bright field and dark field illumination for selective or simultaneous illumination of a subject. Typical systems that provide both bright and dark field illumination use a diffuse on-axis light to provide high angle bright field illumination at relatively large distance of about fifty millimeters or more, and a low angle ring light such as a series of light emitting diodes arranged in a ring to provide low angle dark field illumination at short distances of about twenty-five millimeters or less. Often, one or both of the lighting systems are external to the housing of the scanning device. While these prior art systems are useful in producing proper illumination, they require a large number of components and are expensive to implement. Furthermore, as one or both of the lighting components is often external to the scanning device, the devices are substantially affected by environmental lighting conditions.

### BRIEF DESCRIPTION OF THE SEVERAL VIEWS OF THE DRAWINGS

FIG. 1 is a perspective view of a scanning system including a scanning device and host computer.

FIG. 2 is a cutaway side view of the scanning system of FIG. 1.

FIG. 3 is a block diagram of a control system for the scanning device of FIG. 2.

FIG. 4 is an exploded view of the scanning device of FIG. 1.

FIG. 5 is a top view of the illumination board of the scanning device of FIG. 1.

FIG. 6 is a perspective view of a right angle light emitting diode of the illumination board of FIG. 5.

FIG. 7 is a radiation diagram of one embodiment of a light emitting diode.

FIG. 8 is a cutaway side view of the scanning device of FIG. 1, illustrating the light characteristics when illuminating a flat surface.

FIG. 9 is a cutaway side view of the scanning device of FIG. 1, illustrating the light characteristics when illuminating a rough surface.

### BRIEF SUMMARY OF THE INVENTION

The present invention provides an illumination ring for a scanning device which includes a plurality of light emitting diodes directed toward a center of the ring. The radiation spectrum of light emitted from the diodes is selected to provide a viewing angle extending over more than ninety degrees and preferably one hundred and twenty degrees or more. Because of the wide viewing angle, the light emitting diodes provide both low and high angle light to an illuminated surface, thereby providing both bright and dark field illumination, without the need for multiple devices or the need to angle the light emitting diodes in the array.

In one aspect, the present invention provides a scanning device including a camera having a lens focused along a camera axis, a controller, coupled to the image acquisition element for reading an acquired image, and a lighting element for illuminating an image to be read. The lighting element comprises a plurality of light emitting devices, each having a viewing angle of at least ninety degrees and arranged on opposing sides of the lens and providing a spectrum of light radiation providing both a dark field and a bright field illumination.

In another aspect of the invention, the lighting elements are light emitting diodes having a viewing angle extending over more than ninety degrees, and preferably over more than one hundred and twenty degrees. Each of the light emitting diodes in the ring is directed substantially toward the center of the ring.

In another aspect of the invention, the optics of the scanning device are focused between contact and substantially one hundred and fifty millimeters, and more preferably between seventy-five and one hundred and fifty millimeters.

In yet another aspect of the invention, a scanning device is provided including a camera having a lens and an image acquisition sensor, a controller coupled to the image acquisition sensor for reading an acquired image and decoding an encoded symbol, and a lighting element for illuminating an image to be decoded. The lighting element is positioned at a predetermined distance from the camera, and is constructed as a ring of light emitting devices that substantially surround the lens. Each of the light emitting devices is directed substantially toward a camera axis directed through a center of the lens and has a viewing angle that is greater than ninety degrees, and is adapted to provide both a dark field and a bright field illumination on a surface to be imaged.

In another aspect of the invention, the light emitting elements are light emitting diodes directed substantially toward the center of the ring, and along a camera axis directed substantially through a center of the lens.

In still another aspect, the invention provides a method for producing bright and dark field illumination in a scanning device, comprising the steps of arranging a plurality of light emitting elements, each having a viewing angle of greater than ninety degrees, in a ring configuration and directed substantially toward a center of the ring, positioning the ring of light emitting elements to substantially surround a camera including a lens and an image acquisition sensor, and activating the light emitting elements to illuminate a surface including a symbol to be decoded. An image is then acquired and an associated symbol is decoded. The viewing angle of the light emitting diodes is preferably greater than one hundred and twenty degrees.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### DETAILED DESCRIPTION OF THE PREFERRED EMBODIMENT

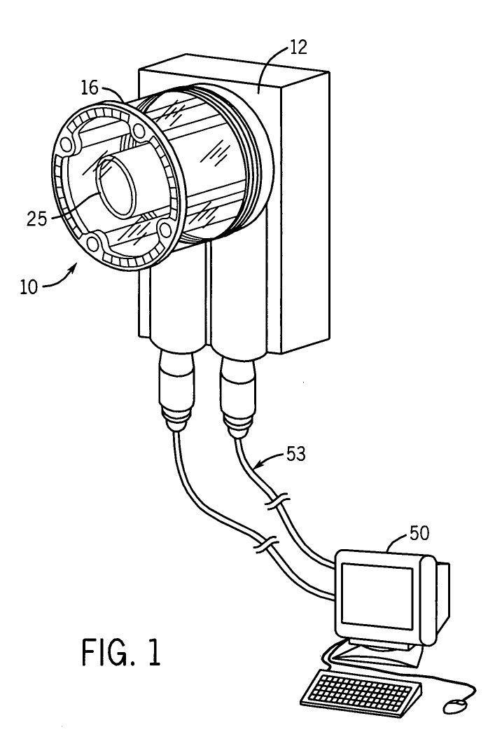

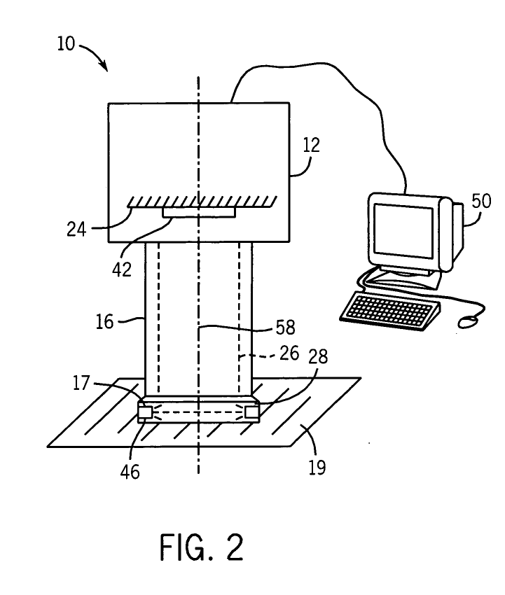

Referring now to the figures and more particularly to FIGS. 1 and 2, a digital scanning device 10 constructed in accordance with the present invention is shown. The digital scanning device 10 is provided in a housing 12 that is connected through a cable 53 to a host computer 50 which receives decode data. A camera including both an imaging sensor 42 (FIG. 2) and a lens system 25 is provided within the housing 12 and substantially centered within the diameter of a tubular illumination pipe 16 along a camera axis 58. The tubular illumination pipe includes a protective ring 17 at a distal end sized and dimensioned to house an illumination board 28 that provides illumination to an underlying surface 19 including a symbol such as a bar code or data matrix to be decoded. The illumination pipe 16 and protective ring 17 are constructed of a transparent material, and preferably a plastic material such as Plexiglas or polycarbonate, to allow for the dispersion of light from the illumination board 28. As shown here, the scanning device 10 is intended for fixed reading applications. However, a hand held scanner or other scanning devices could also be used.

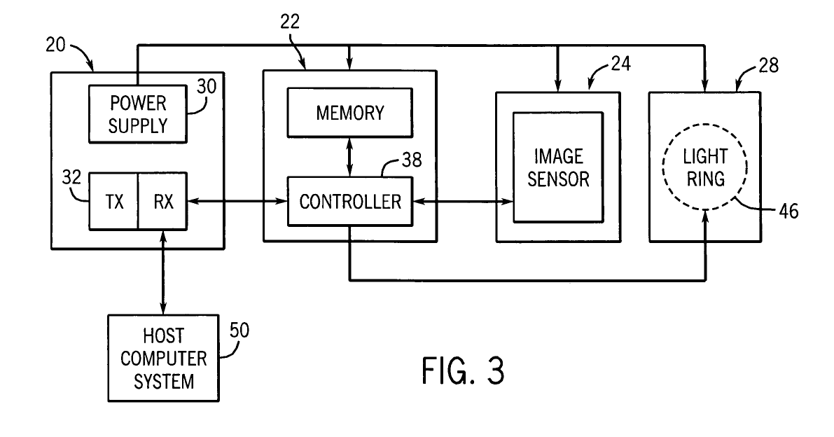

Referring now also to FIG. 3, a typical hardware block diagram for a scanning device 10 is shown. Generally, the scanning device 10 includes a power supply board 20 that provides power to a CPU board 22, and a camera or CAM board 24 which are mounted in the housing 12 of the scanning device 10. As described above, an illumination pipe 16 is coupled between the CAM board 24 and an illumination board 28 which, as described more fully below, includes a plurality of lighting elements such as light emitting diodes or LEDs 46 arranged in a ringed configuration. The pipe 16 is substantially centered about a camera axis 58 extending through the camera, and is of a length selected to position the light emitting diode 46 at a preselected distance from the camera, at a location closer to the surface to be illuminated than the housing 12 of the scanning device 10.

Referring still to FIG. 3, the power supply board 20 includes a power supply 30 for providing logic level power to components in the scanner 10 including the CPU board 22, the CAM board 24, and the illumination PC board 28. A switching element (not shown) can be provided on the power supply board 20 for receiving a user-input signal requesting a scan. The power supply board 20 further includes a transmitter and receiver 32 for transmitting and receiving information from the host system 50 which, as described above, can be connected to the scanning device 10 to receive decode information from the digital scanning device 10, and to transmit data to the scanning device 10. The transmitter/receiver 32 can be any of a number of different types of communication devices including an RS 232 connection to the host system 50 or a PS2 connection, which can be connected to a wedge between the keyboard 52 and the host system 50. Various other wired and wireless communication systems, which will be apparent to those of skill in the art, could also be used.

Referring still to FIG. 3, the central processing unit or CPU board 22 includes a microprocessor or controller 38, and a memory component 34 which can include both random access memory and read only memory. The controller 38 is connected to the memory component 34 for storing data to and retrieving data from memory, to the power supply board 30 for transmitting signals to and receiving signals from the host system 50 through the transmitter/receiver 32, and to the CAM board 24 to receive acquired image data and to operate bright field illumination, as described below, and to the illumination PC board 28 for driving the light elements 46 to provide dark field illumination to a symbol to be scanned, also as described more fully below. Although direct connections are shown between the controller 38 and various other elements, it will be apparent that various I/O device, A/D converters, and other elements can also be provided for implementing communication between the various circuit boards.

Referring still to FIG. 3, the CAM board 24 includes an image acquisition sensor 42 that detects light reflected from a symbol such as a barcode or a data matrix, along with a lens and other optical elements. The image acquisition sensor 42 can be a high resolution sensor, such as a CMOS sensor having pixels provided in an array arranged in rows and columns, and can, for example, be provided on a single chip. A bright field illumination element (not shown), such as an LED, can also optionally be provided on the CAM board 24 and can be activated by the controller 38 independently of or in conjunction with the bright and dark field illumination 46 provided on the illumination board 28.

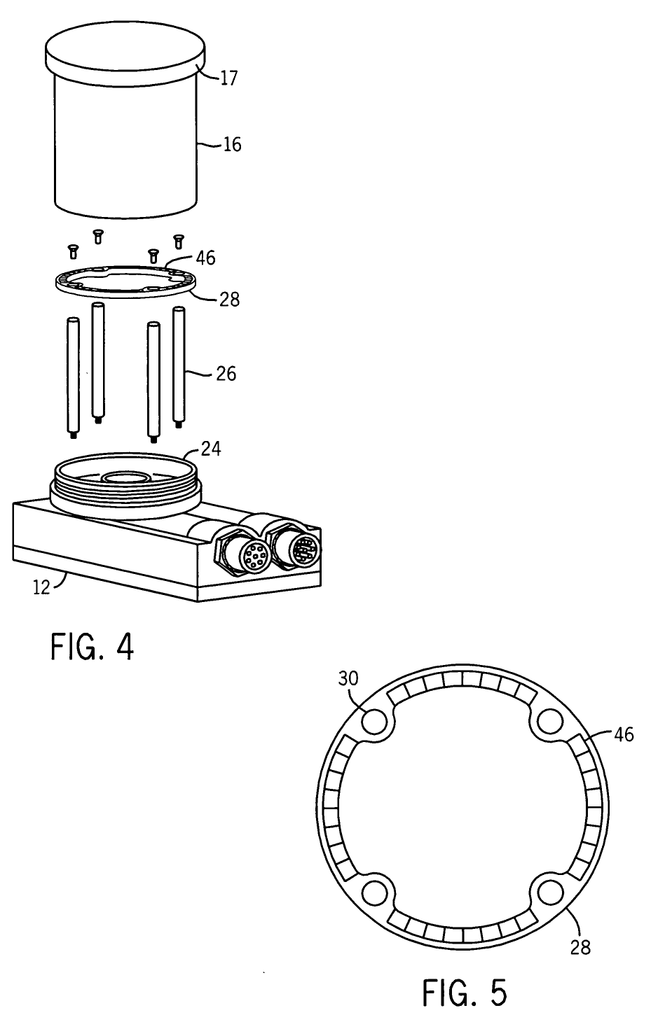

Referring again to FIG. 4, as described above, the illumination PC board 28 includes a plurality of light emitting diodes or LEDs 46 arranged in a ring configuration which, as shown, can be circular. The LEDs 46 are connected to the power supply 20 and to the CPU board 22 such that the controller 38 can selectively control the LEDs 46, either individually, as a group, or in connected segments, to provide illumination from the scanning device 10. Referring now also to FIG. 3, the illumination board 28 is connected to the housing 12 through a plurality of standoffs 26, which provide the conductors necessary for connecting the illumination board 28 to the components of the scanning system provided in the housing 12. The standoffs 26 are received in the pipe 16, and operate with the pipe 16 to position the light emitting diodes 46 adjacent a surface 19 having a symbol to be imaged, and a predetermined distance from the camera 24 extending at least beyond the distal end of the lens 25. Referring now to FIG. 5, the opposing ends of the standoffs 26 are received in apertures 30 in the board 28 which are spaced around the circumference of the light ring. Although a circular ring array is shown here, the light elements provided in the illumination PC board 28 can be arranged in various configurations, and the term ring is intended to include various polygonal, rectangular, square, oval, and other configurations. Furthermore, although a ring configuration is preferable, arrays of one or more light emitting diode can also be arranged on opposing sides of the lens 25. These arrays can be provided either in a linear configuration, wherein the light emitting diodes on opposing sides face one another, or arranged in arcs, directed toward the camera axis 58.

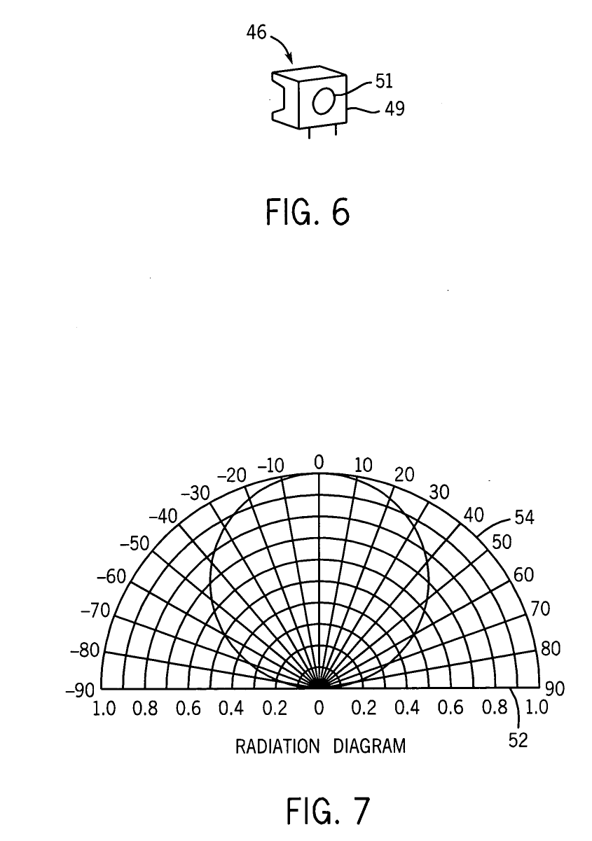

Referring still to FIG. 5 and now also to FIG. 6, the printed circuit board 28 is generally ring-shaped, and receives a plurality of LEDs 46. The LEDs 46 are right angle devices, and preferably surface mount devices which, when mounted on the printed circuit board 28, are configured to emit a spectrum of radiated light from a light emitting element 51 provided on a side 49 of the device. The LEDs 46 are arranged on the illumination board 28 with the light emitting side 49 pointed inwardly and toward the center of the illumination ring. Referring now again to FIG. 2, the LEDs 46 can be directed at and perpendicular to the camera axis 58 centered in the illumination pipe 16, as shown in phantom. In some applications, however, it may be desirable to angle the LEDs 46 at an angle that can range anywhere between forty-five and ninety degrees to the camera axis 58. Preferably, the LEDs 46 are surface mounted side emitting LEDs with the optical axis directed perpendicular to the camera axis 58.

The LEDs 46 are selected to radiate sufficiently bright light over an angular spectrum to provide a viewing angle of more than ninety degrees, and preferably one hundred and twenty degrees or more, to provide both dark and bright field illumination. Referring now also to FIG. 7, a radiation spectrum illustrating spatial distribution of illumination light along a first axis 54 and a percentage of luminous intensity along a second axis 56 for an exemplary LED 46 is shown. As shown here, and in the preferred embodiment of the invention, the viewing angle of the LED 46 extends over 120 degrees. The light has its greatest intensity at the center, at zero degrees along axis 54, and the intensity of the emitted light falls as it radiates further from this center point, providing a range of diffuse light. The angle at which brightness is half of the brightness at dead center on opposing sides of the center is sixty degrees, providing a viewing angle of approximately one hundred and twenty degrees. Because sufficiently bright light is radiated at a distribution of sixty-degrees from opposing sides of the center, and therefore at greater than forty-five degrees from the center of the light emitting diode 46, the radiated light includes light radiated both at less than forty-five degrees with respect to the surface 19 to be illuminated and greater than forty-five degrees with respect to the surface 19, thereby providing both low and high angle light.

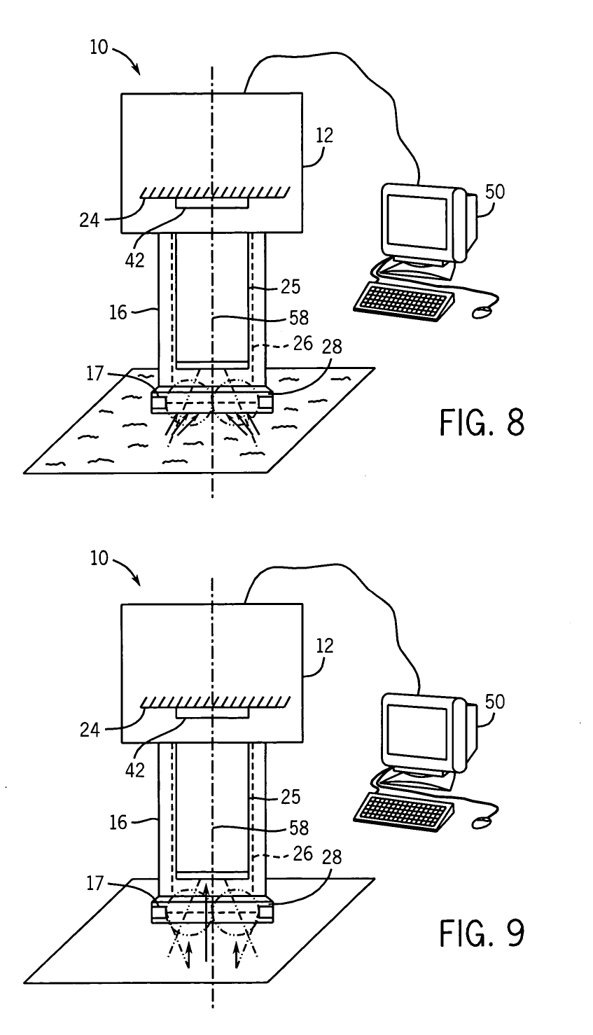

In general if the opening angle of the camera 24 is x degrees, the viewing angle of the LED's 46 is selected to be less than or equal to 180−x degrees. Preferably, the spatial intensity distribution should have high intensity (greater than 50% of the maximum intensity) at angles below 90−x/2 degrees, and a rapid fall-off beyond this angle. Referring now also to FIGS. 8-9, a cutaway view of the light pipe 16 and associated LEDs 46 is shown illustrating the distribution of light from the illumination board 28, and particularly the reflection of light when illuminating both a flat surface and a peened or rough surface. As noted above, the LEDs 46 have a viewing angle of more than ninety degrees. Therefore, the radiated light is diffused around the center point, and includes both high angle and low angle light, and components of light that are directed both horizontally and vertically.

Referring first to FIG. 8, the light emitting diodes 46 include an element of diffused light that is at an angle of less than forty-five degrees to the surface, providing low angle light, and therefore dark field illumination that is useful in imaging the peened surface. Here, the application of diffuse light provides contrast in the acquired image. Referring now also to FIG. 9, because the light also includes high angle light which is at an angle of greater than forty-five degrees, and includes substantial vertical components, when the surface to be imaged is substantially flat, the vertical components of the light are reflected back from the surface, substantially along the camera axis 58, and toward the CAM board 24, also providing low intensity bright field illumination. The radiated light, therefore, provides a spectrum of diffused light that includes both light and dark field illumination at the surface of interest in a single, low cost illumination ring. Moreover, it is not necessary to angle the light emitting diodes to provide the various types of lighting, thereby simplifying manufacturing and further decreasing costs.

In one embodiment of the invention, the LEDs 46 were selected to provide illumination over a viewing angle of approximately one hundred and twenty degrees, therefore providing a sufficient vertically-directed component that light directed on an underlying surface is reflected back to provide bright field illumination while the circle of lights provide dark field illumination as well, as described above. One light emitting diode useful in the application is part number WV-2-15-SWE-UR, available from Vossloh-Schwabe Opto electronics of Kamp-Lintfort, Germany. Other light emitting diodes having a viewing angle of greater than ninety degrees and sufficient light intensity could also be used. When using this diode, however, for optimal performance, the optical set-up of camera 24 uses a twenty-five millimeter lens with a five millimeter extension tube. The lens can be focused between contact and about one hundred and fifty mm, and most preferably between seventy-five and one hundred and fifty mm. Depending on the light emitting diode and sensors selected in a given application, however, a focal length of more or less than one hundred and fifty millimeters may be appropriate.

Referring again to FIGS. 1-3, in operation, the scanning device 10 is activated by a user, either through input from a connected host computer system 50 or by a user-activated trigger providing a control signal to the controller 38 to activate at least a portion of the LEDs 46 on the illumination board 28 to illuminate a symbol to be decoded. Reflected light from the symbol is detected by the image acquisition sensor 42 on the CAM board 24, which has a fixed lens to provide a fixed focal distance. Image data acquired by the sensor 42 is read out by the controller 38, and can be processed to decode the symbol and/or stored in the memory component 34 as a series of pixels. Referring again to FIGS. 9 and 10, because the illumination ring 47 of the illumination board 28 is configured to provide both bright and dark field illumination for the symbol, the symbol can be more easily read, irrespective of the type of underlying surface, thereby providing a more efficient reading system, limiting the need to select a type of illumination prior to reading, and decreasing the overall cost of the scanning device 10.

Although specific embodiments have been shown and described, it will be apparent that a number of variations could be made within the scope of the invention. For example, although a handheld scanner with specific hardware configuration has been described above, it will be apparent to those of ordinary skill in the art that many variations could be provided in the hardware and software described. Furthermore, although specific lighting conditions and symbols have been described, these are not considered to be limitations of the invention, as the methods described herein could be employed in various applications, as will be apparent from the description above. Additionally, although the method has been described above for use in decoding symbols, it will be apparent that similar methods can also be used in several imaging applications, for character recognition and reading processes, and in other applications. Furthermore, although the lighting elements are discussed above as light emitting diodes, it will be apparent that other devices such as laser diodes or other light emitting elements having the types of characteristics discussed above could also be used. It should be understood therefore that the methods and apparatuses described above are only exemplary and do not limit the scope of the invention, and that various modifications could be made by those skilled in the art that would fall under the scope of the invention. To apprise the public of the scope of this invention, the following claims are made:

1. A scanning device, comprising:
a camera including a lens focused along a camera axis;
a controller, coupled to the image acquisition element for reading an acquired image; and
a lighting element for illuminating an image to be read, the lighting element comprising a plurality of light emitting devices each having a viewing angle of at least ninety degrees and arranged on opposing sides of the lens, wherein the lighting element provides a spectrum of light radiation providing both a dark field and a bright field illumination.

2. The scanning device as defined in claim 1, wherein the lighting element comprises light emitting diodes.

3. The scanning device as defined in claim 2, wherein each of the light emitting diodes has a viewing angle extending over substantially one hundred and twenty degrees.

4. The scanning device as defined in claim 2, wherein each of the light emitting diodes in the ring is angled to direct light substantially toward the camera axis.

5. The scanning device as defined in claim 1, wherein the light emitting diodes are arranged in a ring configuration directed toward the camera axis.

6. The scanning device as defined in claim 1, further comprising an illumination pipe for positioning the illumination ring adjacent a symbol to be read.

7. The scanning device as defined in claim 6, wherein a length at the pipe is selected to position the illumination ring on a side of the lens adjacent a reading surface.

8. The scanning device as defined in claim 5, wherein the lens is focused between contact and substantially one hundred and fifty millimeters.

9. The scanning device as defined in claim 7, wherein the lens is focused at a distance between substantially seventy-five and one hundred and fifty millimeters.

10. A scanning device for reading and decoding symbols, the scanning device comprising:
a camera including a lens and an image acquisition sensor;
a controller, coupled to the image acquisition sensor for reading an acquired image and decoding an encoded symbol; and
a lighting element for illuminating an image to be decoded, the lighting element comprising a ring of light emitting devices being positioned at a predetermined distance along a camera axis extending through a center of the lens and substantially surrounding the lens, each of the light emitting devices being directed substantially at the camera axis and providing a viewing angle of greater than ninety degrees and adapted to provide both a dark field and a bright field illumination on a surface to be imaged.

11. The scanning device as defined in claim 10, wherein the light emitting elements are side emitting light emitting diodes that are directed substantially toward the center of the ring and perpendicular to the camera axis.

12. The scanning device as defined in claim 10, further comprising a tubular element coupled between the illumination ring and the camera, the tubular element positioning the light emitting diodes at the predetermined distance from the camera.

13. The scanning device as defined in claim 12, wherein the predetermined distance is selected to position the illumination ring at a point past the distal end of the camera.

14. The scanning device as defined in claim 10, wherein the light emitting diodes have a viewing angle of substantially one hundred and twenty degrees.

15. The scanning device as defined in claim 11, wherein the side emitting light emitting diodes are surface mounted to a printed circuit board.

16. A method for providing bright and dark field illumination in a scanning device, the method comprising:
arranging a plurality of light emitting elements, each having a radiation spectrum of greater than ninety degrees, in a ring configuration and directed substantially toward a center of the ring;
positioning the ring of light emitting elements to substantially surround a camera including a lens and an image acquisition sensor;
activating the light emitting elements to illuminate a surface including a symbol to be decoded; and
acquiring an image and decoding the symbol.

17. The method as recited in claim 16, further comprising the step of maintaining the light emitting elements at a position between a symbol to be read and a lens of the camera.

18. The method as recited in claim 16, wherein the radiation spectrum is substantially one hundred and twenty degrees.

19. The method as recited in claim 16, further comprising the step of locating the light emitting elements a predetermined distance from the camera.

20. A light array for a scanning device, the light array comprising:
a ring-shaped printed circuit board; and
a plurality of light emitting diodes arranged around the printed circuit board to direct light substantially at a center of the ring, wherein each of the light emitting diodes emits light over a viewing angle of greater than ninety degrees, thereby providing both bright field and dark field illumination.

21. The light array as defined in claim 20, wherein the light emitting diodes each have a viewing angle of substantially one hundred and twenty degrees.

22. The light array as defined in claim 20, wherein the light emitting diodes are surface mounted side emitting light emitting diodes.
